(19) United States
(12) Patent Application Publication
(10) Pub. No.: US 2007/0275693 A1
(43) Pub. Date: Nov. 29, 2007

(54) Method for Determining Use Charges For a Field Device of Automation Technology

(75) Inventor: Christian Seiler, Auggen (DE)

Correspondence Address: BACON & THOMAS, PLLC, 625 SLATERS LANE, FOURTH FLOOR, ALEXANDRIA, VA, 22314, US

(73) Assignee: Endress + Hauser Process Solutions AG, Reinach (CH)

(21) Appl. No.: 11/547,849

(22) PCT Filed: Mar. 23, 2005
(86) PCT No.: PCT/EP05/51342

§ 371 Date: Jul. 31, 2007

(30) Foreign Application Priority Data
Apr. 6, 2004 (DE) 10 2004 017 318.4

(51) Int. Cl. H04M 11/00

(52) U.S. Cl. 455/406

(57) ABSTRACT

A method for determining use charges for a field device of automation technology, according to which measured values are transmitted to a customer via a public communication network (K) as digital/analog signals, and the transmission of the signals in the public communication network (K) is monitored by a switching unit (S), which generates a charge base value as a function of the transmission of the signals and the use charges are obtained from the charge base value.

The invention relates to a method for determining use charges for a field device of automation technology, as such method is defined in the preamble of claim 1.

In automation technology, field devices are often applied for registering and/or influencing process variables. Examples of such field devices are fill level measuring devices, mass flow measuring devices, pressure and temperature measuring devices, etc., which as sensors register the corresponding process variables, fill level, flow, pressure, and temperature, respectively.

For influencing process variables, actuators are applied, such as e.g. valves, which control the flow of a liquid in a section of pipeline, or pumps, which change the fill level in a container.

A large number of such field devices are manufactured and sold by the firm Endress+Hauser.

As a rule, field devices in today's manufacturing plants are connected via field bus systems (Profibus, Foundation Fieldbus, HART, etc.) with superordinated units, e.g., control systems or units. These units serve for process control, process visualization, process monitoring, as well as for commissioning of the field devices.

Sometimes field bus systems are also connected with public communication networks.

A trend in the financing of industrial plants is in the direction, evermore, of no longer buying the parts of the plant, but, instead, only renting them (leasing).

Plant operators are mainly interested in the measured values which field devices deliver. As known from European Patent Application EP 1 181 036, it is conceivable that the end customer will in the future only be sold measured values and no longer the field devices required for registering the measured values.

A problem in the case of sale of measured values is, however, the determining of the use charges for the delivering field device.

An object of the invention is, therefore, to provide a simple and cost-favorable method for determining use charges for a field device of process automation technology.

This object is achieved by the features defined in claim 1.

Advantageous further developments of the invention are set forth in the dependent claims.

An essential idea of the invention is to bill the customer for the use of a public communication network. To this end, a switching unit is provided in the public communication network which monitors the transmission of digital/analog signals delivered by the field device and generates a charge base value as a function of the transmission. From this charge base value, the use charges for the relevant field device are finally determined.

An essential advantage of the invention is that the use charges for a field device are automatically registered, i.e. without having to install any additional unit on the field device, and the use charges can be automatically charged to the account of the customer. To accomplish this, available infrastructures and accounting systems are used.

For instance, the customer can receive a monthly bill from a telecommunications provider which shows in the amount of the bill an item corresponding to the use of the field device and the telecommunications provider can forward to the provider of the field device payment corresponding to this item, following payment of the bill by the end customer.

Registered as use base value can be e.g. the length of time used for the transmission of the data. The more data transmitted during a connection, the more the customer has to pay.

In an alternative embodiment of the invention, the amount of the transmitted data is registered as the use base value.

In a further alternative embodiment of the invention, only the number of transmissions, i.e., how often a measured value was requested, is registered.

For the transmission of the data, two alternatives are possible. Either the field device independently brings about the transmission, e.g., on the basis of a scheduling program, or the transmission is initiated by the customer by sending a corresponding signal to the field device.

The invention will now be explained in greater detail on the basis of an example of an embodiment shown in the drawing, the figure of which shows as follows:

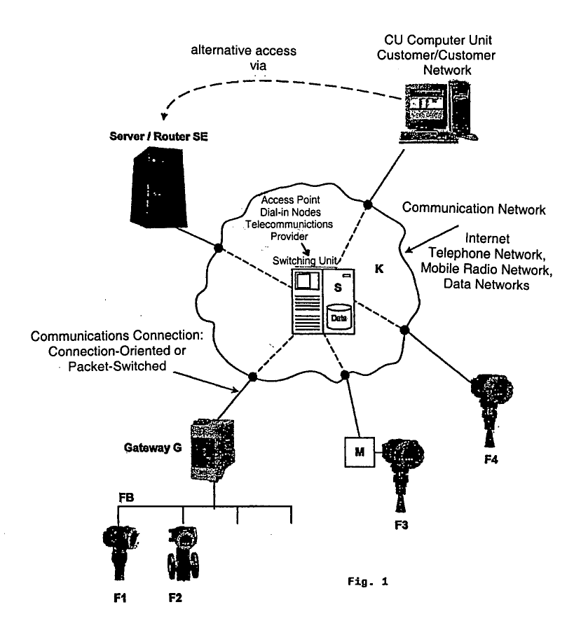

FIG. 1 A plurality of field devices connected with a public communication network.

In FIG. 1, two field devices, F1 and F2, are shown schematically as being connected via a field bus system FB (e.g., HART, Profibus, Foundation Fieldbus) with a gateway G. Gateway G can be e.g., the Fieldgate product of the firm Endress+Hauser.

Gateway G is connected with a public communication network K to which a computer unit CU is connected on the customer side. Additionally connected with the public communication network K is a switching unit S, which monitors and/or controls the use of the network K by the customer. The switching unit S can be a usual metering system of a communications provider (e.g., Telecom, AOL). By way of the communication network K, the computer unit CU and the field devices, F1, F2, or G, can exchange data.

Alternatively possible are field devices which make use of communication interfaces and functions corresponding to those of the gateway. In such cases, the field devices themselves execute the functions of the gateway.

By way of example, a field device F3 is shown which is additionally connected with an external communications module M, which at least partially makes use of communication interfaces and functions corresponding to those of gateway G. By the communication module M, the field devices are easily connectable with the public communication network K. A possibility here is that the communication module M optionally contains only the necessary communication interface, and the necessary communication software is integrated in the field device F3.

Also shown is a field device F4, which itself makes use of an integrated communication interface and the necessary functions corresponding to those of the gateway G. Field devices embodied in this way, themselves execute the functions of the gateway G.

The method of the invention will now be explained in greater detail. The field device F1 registers a measured value MV, e.g., the fill level in a storage tank T1. This measured value is to be transmitted via the public communication network K to the computer unit CU of the customer. Using the computer unit CU, the customer dials for this purpose e.g. a special service number which is subject to charges, i.e. a number such as the 0190 numbers known for such purpose in Germany, in order to establish a communications connection directly between the computer unit CU and the gateway G, or the field device F1, as the case may be. Once the communications connection is established, the computer unit CU sends an appropriate signal directly to the gateway G, or via the gateway G, to the desired field device F1. Then the transmission of the desired information takes place, e.g., the current measured value MV of the field device F1 is reported to the computer unit CU. The transmission occurs, as a function of the type of network, either as analog or digital data.

Naturally, other measured values with accompanying timestamps or other information, e.g., diagnostic information, can be transmitted. Consequently, the time development of the fill level in the selected storage tank T1, or the current state of the field device F1 can be displayed in the computer unit CU.

Following successful transmission of the desired information, the communications connection is terminated. In the switching unit S, the transmission of the signals was monitored. Associated therewith, a charge base value is determined in the switching unit from the communications connection between computer unit CU and gateway G.

Thus, according to the clock pulse values predetermined in the switching unit S for this communications connection, the charge units can be summed over the duration of the communications connection.

Alternatively, the charge unit per clock pulse can be specified in the switching unit S. These charge units represent a charge base value from which the use charges for the field device F1 can be obtained.

In an alternative embodiment of the invention, the gateway G itself dials a service number and transmits the desired information (e.g., measured values) to the computer unit CU of the customer. On the customer side, instead of the computer unit CU, another possibility is to provide a plurality of computer units which are networked via a local network.

In a further alternative embodiment of the invention, the gateway G is activated via a server SE (e.g. an Internet server), whereupon the gateway G connects itself via a service number with the Internet, a customer network, or an individual computer.

The measured data can in these cases also be transmitted to the customer in the form of data reports, e.g. as email.

In a further embodiment of the invention, a measurement location composed of one or more field devices is queried via a server SE (e.g., an Internet server), which, in the case of query to a particular field device, establishes, via a service number, a connection to the gateway G and, consequently, to the attached field device.

In an alternative embodiment of the invention, also data-packet-oriented connections are provided. For this, modern transmission technologies are needed, examples being DSL technology, WLAN-spots, GPRS, or UMTS. In such case, no longer the length of time is decisive for the connection, but instead the data amounts exchanged between the separate communication participants are calculated. The charge base units are generated in a corresponding switching unit S in an access node of the telecommunications provider.

Also in the case of a widely distributed transmission of short messages via known mobile radio, or telephone, networks (e.g., SMS), a data service is involved which transmits separate data packets, wherein the use charges per data packet can be individually formed via the number of the data switching central.

In mobile radio, or telephone, networks, so called SIM cards are used for identifying the participant. Data transmission occurs between gateway G and the computer unit CU via a mobile radio, or telephone, network. Then, corresponding to the SIM card used in the gateway G, individual prices per transmitted amount of data can be determined.

The use charges are automatically charged to the customer. For this purpose, present infrastructures and accounting systems are used. For instance, the customer receives a monthly bill from the telecommunications provider which cares for the transmission of the signals and this bill shows an item in the billed amount corresponding to the use of the field devices. The communications provider pays an amount corresponding to this item to the provider of the field devices, following payment of the bill by the end customer.

A significant advantage of the invention is that the use charges for a field device can be automatically registered, i.e., without having to install additional equipment at the field device or in the communication network.

The method of the invention is especially well suited for use in the field of industrial inventory control and for the control of logistic chains (supply chain management). In both cases, the application programs which are used rely on current, measured values from remote plants.

With the help of the method of the invention, it is possible for the first time to provide field devices to end customers as leased objects, with the use of the field devices being charged to the end customers in very simple manner.

1-9. (canceled)

10. A method for determining use charges for a field device of automation technology, wherein the field device registers measured values, which are transmitted to a customer via a public communication network (K) as digital/analog signals, comprising the steps of:
monitoring the transmission of the signals in the public communication network (K) by a switching unit S which generates a charge base value as a function of the transmission of the signals; and
obtaining the use charges from the charge base value.

11. The method as claimed in claim 10, further comprising the step of:
registering the length of time for the transmission of the signals in the switching unit as the charge base value.

12. The method as claimed in claim 10, further comprising the step of:
registering the amount of data in the transmitted signals in the switching unit S as the charge base value.

13. The method as claimed in claim 10, further comprising the step of:
registering the number of transmitted data packets in the switching unit S as the charge base value.

14. The method as claimed in claim 10, further comprising the step of:
registering the number of transmissions in the switching unit S as the charge base value.

15. The method as claimed in claim 10, wherein:
the field device independently initiates the transmission of the signals.

16. The method as claimed in claim 10, wherein:
the customer sends a signal to the field device which initiates the transmission of the signals.

17. The method as claimed in claim 10, wherein:
the operator of the public communication network (K) bills the customer.

18. The method as claimed in claim 10, wherein:
a server (SE) sends a control signal to a particular field device (F1, F2), which initiates transmission of the signals.
